(19) United States
(12) Patent Application Publication
(10) Pub. No.: US 2015/0379508 A1
(43) Pub. Date: Dec. 31, 2015

(54) CONTROLLING USAGE OF ACQUIRER TOKENS STORED WITHIN A MERCHANT SYSTEM

(71) Applicant: TOUCH NETWORKS AUSTRALIA PTY LTD, Melbourne, Victoria (AU)

(72) Inventor: Jason Andrew VAN, Melbourne (AU)

(73) Assignee: TOUCH NETWORKS AUSTRALIA PTY LTD, Melbourne (AU)

(21) Appl. No.: 14/768,336

(22) PCT Filed: Feb. 12, 2014
(86) PCT No.: PCT/AU2014/000110

§ 371 Date: Aug. 17, 2015

(30) Foreign Application Priority Data
Feb. 18, 2013 (AU) 2013900517

(51) Int. Cl. G06Q 20/38

(52) U.S. Cl. CPC G06Q 20/3821

(57) ABSTRACT

A method for controlling usage of one or more acquirer tokens stored within a merchant system. The method comprises receiving a payment request to make a payment corresponding to a user account having associated therewith an acquirer token that enables payment to be made by communication of the acquirer token to an acquirer system, determining whether to allow the payment to be made by communicating the acquirer token to the acquirer system based on whether a payment channel via which the payment request is received is authorised for use of the acquirer token, and communicating the acquirer token to the acquirer system upon a positive determination to allow the payment.

### FIELD

The present invention relates to a method of controlling usage of acquirer tokens stored within a merchant system and a merchant system for controlling usage of acquirer tokens.

### BACKGROUND

Some existing e-commerce systems employ a token as a means of allowing a user to use a previously entered credit card in a subsequent transaction without storing the details of the credit card at a merchant system.

In one example a user connects to a merchant system via the Internet and provides credit card details. The merchant system asks the user if they want to store the credit card details for a future transaction. Assuming the user wants to store credit card details, the merchant system sends a request to a relevant acquirer system (usually a system operated by the user's bank) asking it for approval of the current transaction and a token for future transactions. If the transaction is valid, the acquirer system sends an approval message and also sends the merchant a token. In a subsequent transaction for the same user, the user can be asked whether the transaction should proceed based on a previously used credit card during the transaction even though the full details of the credit card are not actually stored, e.g. with a message containing part of the credit card number such as “Do you want to pay with credit card number “1234 xxxx xxxx 4321”? If the user agrees, the token is sent to the acquirer system, and used by the acquirer system to retrieve the relevant credit card number for the transaction.

A problem with this approach is that a person who gains access to the user's account with the merchant system can make transactions using the pre-stored token.

### SUMMARY

In a first aspect, the invention provides a method for controlling usage of one or more acquirer tokens stored within a merchant system, the method comprising:

receiving a payment request to make a payment corresponding to a user account having associated therewith an acquirer token that enables payment to be made by communication of the acquirer token to an acquirer system;

determining whether to allow the payment to be made by communicating the acquirer token to the acquirer system based on whether a payment channel via which the payment request is received is authorised for use of the acquirer token; and

communicating the acquirer token to the acquirer system upon a positive determination to allow the payment.

In an embodiment, the method comprises determining whether to allow the payment by determining whether there is a merchant token for the payment channel that has been associated with the acquirer token.

In an embodiment, the method comprises receiving the merchant token from a user device.

In an embodiment, the method comprises creating a new merchant token in response to a request from an authorised user.

In an embodiment, the method comprises applying an expiry condition to the merchant token during creation of the merchant token that is independent of the acquirer token and expiring the merchant token upon the expiry condition being met.

In an embodiment, the method comprises independently establishing a merchant token for each of a plurality of channels.

In an embodiment, the method comprises establishing a separate acquirer token for each merchant token.

In an embodiment, the method comprises receiving the payment request at a payment interface to a merchant system.

In a second aspect, the invention provides a merchant system arranged to control usage of one or more acquirer tokens stored within the merchant system, the merchant system arranged to:

receive a payment request to make a payment corresponding to a user account having associated therewith an acquirer token that enables payment to be made by communication of the acquirer token to an acquirer system;

determine whether to allow the payment to be made by communicating the acquirer token to the acquirer system based on whether a payment channel via which the payment request is received is authorised for use of the acquirer token; and

communicate the acquirer token to the acquirer system upon a positive determination to allow the payment.

In an embodiment, the merchant system is arranged to determine whether to allow the payment by determining whether there is a merchant token for the payment channel that has been associated with the acquirer token.

In an embodiment, the merchant system is arranged to receive the merchant token from a user device.

In an embodiment, the merchant system is arranged to create a new merchant token in response to a request from an authorised user.

In an embodiment, the merchant system is arranged to apply an expiry condition to the merchant token during creation of the merchant token that is independent of the acquirer token and further arranged to expire the merchant token upon the expiry condition being met.

In an embodiment, the merchant system is arranged to independently establish a merchant token for each of a plurality of payment channels.

In an embodiment, the merchant system is arranged to establish a separate acquirer token for each merchant token.

In an embodiment, the merchant system is arranged to receive the payment request at a payment interface of the merchant system.

In a third aspect, the invention provides a merchant system comprising:

a plurality of payment interface modules, each corresponding to at least one different payment channel for communicating with the merchant system to make a payment corresponding to a user account, wherein a first payment interface module stores a merchant token for a first user; and

a user account manager storing a plurality of user records including a user record for the first user, the first user record storing the merchant token in association with an acquirer token that enables payment to be made by communication of the acquirer token to an acquirer system,

wherein the first payment interface module is arranged to process a payment request associated with the first user and allow the payment request to continue upon successfully checking the presence of the merchant token, and thereafter communicate the merchant token to the user account manager as part of the payment request, and

the user account manager is arranged to receive the merchant token and, upon successfully checking that the merchant token is stored in association with the acquirer token, communicate the acquirer token to the acquirer system.

In an embodiment, a second payment interface module stores an additional merchant token for a first user; and

the user account manager stores the additional merchant token in association with the acquirer token that enables payment to be made by communication of the acquirer token to an acquirer system,

wherein the second payment interface module is arranged to process a payment request associated with the first user and allow the payment request to continue upon successfully checking the presence of the additional merchant token, and thereafter communicate the additional merchant token to the user account manager as part of the payment request, and

the user account manager is arranged to receive the additional merchant token and, upon successfully checking that the additional merchant token is stored in association with the acquirer token, communicate the acquirer token to the acquirer system.

In an embodiment, a second payment interface module stores an additional merchant token for a first user; and

the user account manager stores the additional merchant token in association with an additional acquirer token that enables payment to be made by communication of the acquirer token to an acquirer system,

wherein the second payment interface module is arranged to process a payment request associated with the first user and allow the payment request to continue upon successfully checking the presence of the additional merchant token, and thereafter communicate the additional merchant token to the user account manager as part of the payment request, and

the user account manager is arranged to receive the additional merchant token and, upon successfully checking that the additional merchant token is stored in association with the additional acquirer token, communicate the additional acquirer token to the acquirer system.

### BRIEF DESCRIPTION OF DRAWINGS

Embodiments of the invention will now be described by way of example with reference to the accompanying drawings in which:

FIG. 1 is a block diagram showing a merchant system communicating with exemplary user devices and acquirer systems;

FIG. 2 is a block diagram showing more detail of the merchant system;

FIG. 3 is a block diagram showing the storage of merchant and acquirer tokens of a first example;

FIG. 4 is a block diagram showing the storage of merchant and acquirer tokens of a second example;

FIG. 5 shows a flow chart of an embodiment; and

FIG. 6 shows further detail of an authorisation checking step of FIG. 5.

### DETAILED DESCRIPTION

Referring to the drawings, there is shown a merchant system 110 that has a plurality of payment interface modules 111,112,113,144 that provide different channels for making payments in respect of a user account managed by a user account manager component of the merchant system. Such payments require approval by an acquirer. Accordingly, by way of example, the merchant system is shown communicating with two acquirer systems although there may be many more acquirer systems connected to the merchant system. In one example, the first acquirer system 121 may be a credit card provider and the second acquirer system 122 may be the merchant's bank or the user's bank. Typically, such acquirer systems allow an acquirer token (a “Token1”) to be stored by the merchant system, to reduce the level of payment details that need to be entered in a subsequent transaction and to avoid the need to store credit card details (for example, an acquirer token corresponding to a previously provided credit card).

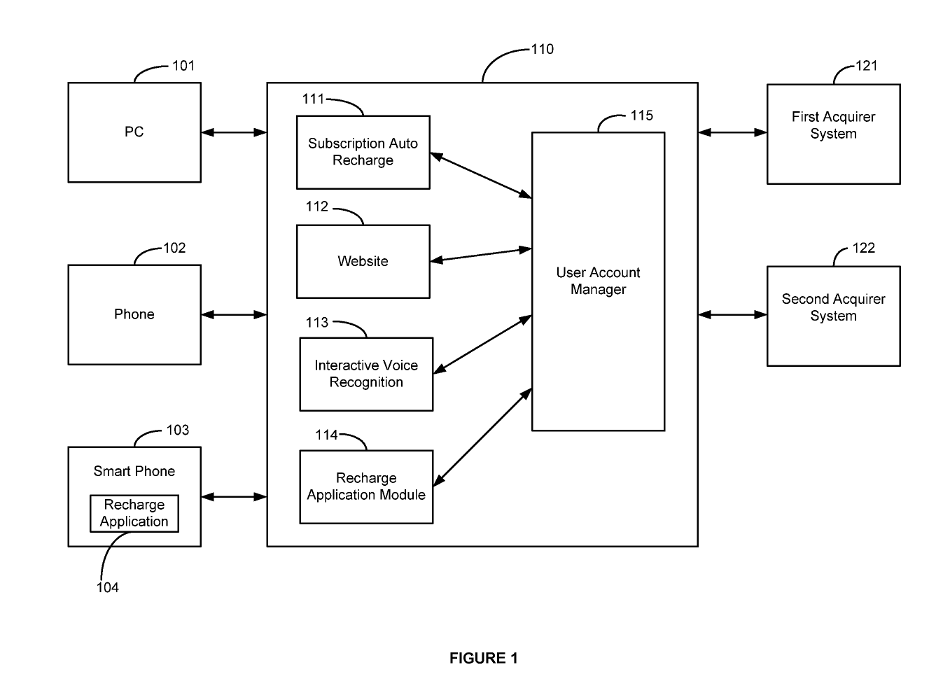

FIG. 1, also shows, by way of example a number of user devices, such as a personal computer 101, telephone 102, and smart phone 103 which may be used to initiate payments using a user account.

It will be appreciated from the above that with multiple payment interface modules, there are a number of ways to access a user's account. Accordingly, a security flaw in any of them might present a risk to a user's account and allow unwanted use of the stored acquirer token. Further, there may be many different devices associated in with an account such as for a family or a business that may seek to access the account.

The present technique seeks to address the problem that a person who gains access to the user's account with a merchant system can make transactions using the pre-stored acquirer token. Such transactions may be nefarious or relatively innocent. An example of a nefarious transaction might be a user's merchant account being hacked. An example of more innocent transaction might be in the context of a user allowing another member of their family such as a child access to an account for purchasing digital content such as music files for a home computing device and the child purchasing a large number of applications (“Apps”) for a hand held electronic device such as an iPod Touch (iPod Touch is a trade mark of Apple Inc, of Cupertino, Calif. USA).

Advantageously, embodiments of the invention allow the use of acquirer tokens to be maintained while providing a greater level of control over the acquirer tokens by determining whether the acquirer token is approved for the channel used to make a payment request. In one embodiment, this is achieved by employing merchant tokens and associating the merchant token (“Token2”) with the acquirer token (Token1) such that a merchant token is needed to use the acquirer token for payment via a particular channel to thereby control the channels that can be used for payment.

In FIG. 1, examples of payment interface modules which provide different channels for accessing a user account are given in the context of a telecommunications service provider system where a user account may correspond to a number of different user devices and service, such as mobile phones, home phones, or other mobile devices (such as tablet computers, portable modems (e.g. 3G or 4G modems), an internet service and the like. The user account stored in the merchant system 110 may be used to pay for post-paid services such as a monthly internet account or pre-paid services such as pre-paid mobile phone recharges having a defined usage quota. The merchant system may be also be used to purchase other products such as mobile devices and accessories or electronic media such as music or movies. Accordingly, it will be appreciated that storage of a token against a user account carries the risk that it could be used to incur significant expense.

In the example of FIG. 1, there are shown a number of payment interface modules in the forms of a subscription auto recharge module 111 which can be used to set up an automatic recharging of a prepaid mobile phone; a website 112 which can be used to purchase recharges of mobile phones or other products; an interactive voice recognition system 113 which can also be used to make payments for mobile recharges; and a recharge application module 114 adapted to receive requests from a recharge application 104 stored on smart phone 103.

In one embodiment, each of the payment interface modules 111, 112, 113, 114 provides an alternative payment channel for making payment using the user account managed by user account manager 115. In another embodiment, a greater level of granularity may be employed by defining a payment channel by also considering the user device 101, 102, 103 from which a payment request is received as part of the channel. This enables a request from different sources to be treated differently.

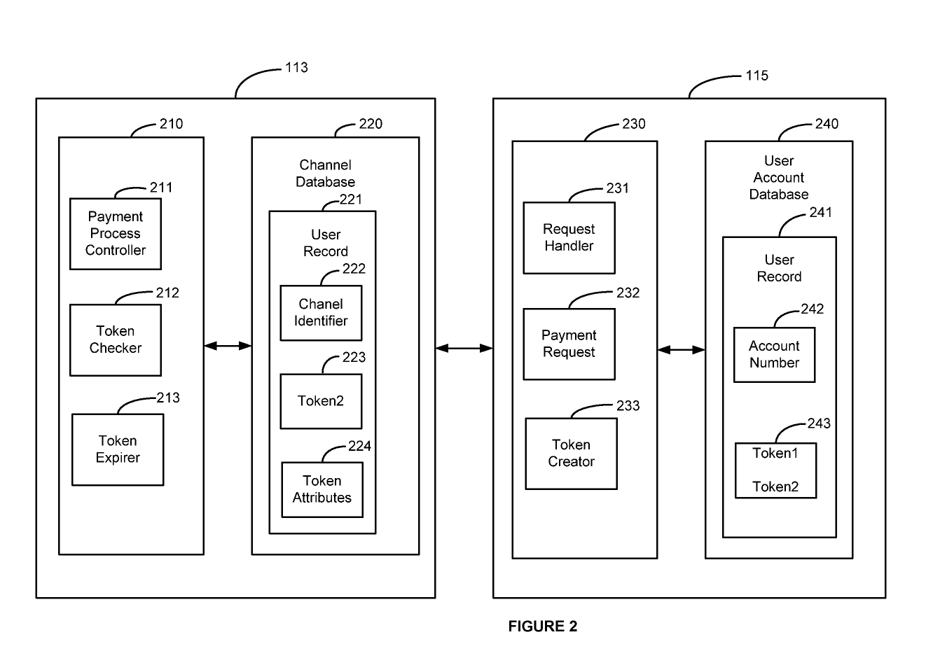

Accordingly, referring to FIG. 2, there is shown further detail of an exemplary one of the payment processing modules (the IVR system 113) and the account manager 115. In this respect, it will be appreciated that there are similar functionalities provided within each payment processing module, however the actual processes might be different. For example, in the auto recharge service, calendar functionality is required in order to initiate periodic payments.

The IVR system 113 comprises a processor 210 that implements a number of modules 211, 212, and 213 in order to implement the functionality of the system. Similarly, memory 220 stores a channel database comprised of a plurality of user records 221. FIG. 2 shows one example of a user record 221.

When a payment request is received, control of the payment process via the IVR system is under the control of the payment process controller 211 which implements the necessary rules for completion of a transaction. The payment process controller 211 calls upon a token checker 212 in response to a user indicating that they have stored their details. In this respect, their user record includes the Token2 223 and any token attributes 224 (such as an expiry date). Optionally, the user record may incorporate an additional channel identifier 222, such as a user's mobile device. The token checker 212 determines that the Token2 is stored and passes it to the payment process controller 211. The payment process controller 211 sends further details of the payment request together with the Token2 to the account manager 115.

The account manager also comprises a processor 230 and a memory 240 storing a user account database. A request handler 231 implemented by the processor 230 receives the request from the IVR system 113 and attempts to process the transaction by checking the user record for the user 241 which includes data such as the account number 242 and other billing details to determine whether a Token1 is stored in association with the Token2 243. Upon the Token2 being stored in association with the Token1, the payment request module 232 communicates with the acquirer system 121,122 in order to confirm payment based on the stored details.

The drawings also show that the account manager also has a token creator 233 for creating Token2s as needed. The IVR system 113 has a token expirer 213 for expiring the token2 stored on the user record of the channel database as needed.

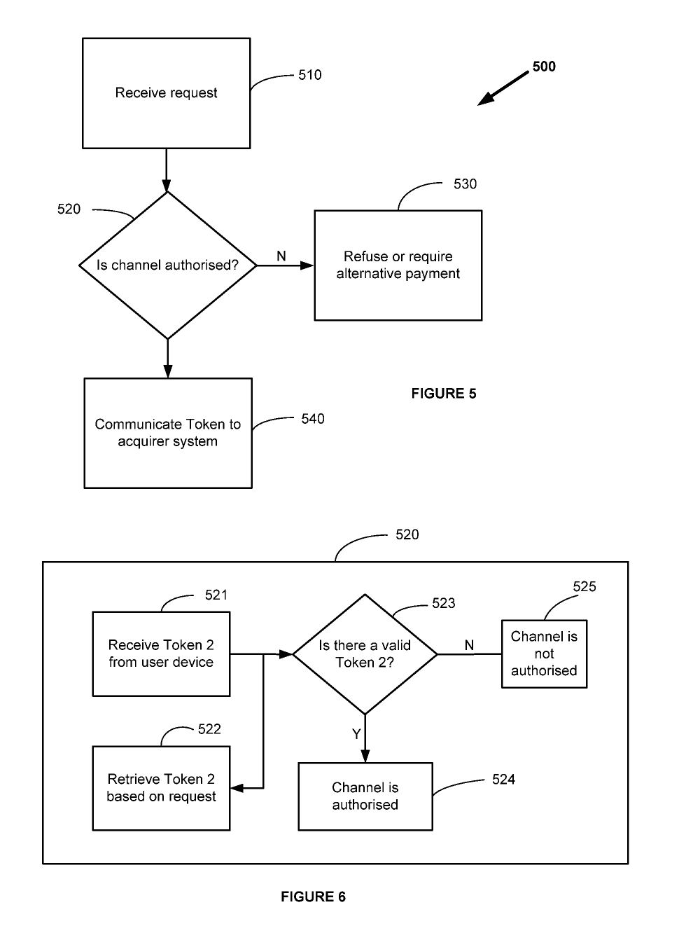

Turning to FIG. 5, a method of an embodiment is shown. The method involves receiving a payment request 510 and determining whether the channel via which the payment request is received is authorised 520. If the channel is authorised for use of a Token1 (an acquirer token) the Token1 is communicated to the acquirer system 540. If the channel is not authorised, the method involves refusing the transaction or requiring an alternative payment to be made 530.

FIG. 6 shows detail of the step 520 of determining whether a channel is authorised. Depending on the embodiment, the method may involve retrieving a Token2 based on the payment request 522 or receiving a Token2 from the user device 521 (in the case of the mobile self-care application). The method then involves determining whether there is a valid Token2 523. The process for determining whether there is a valid Token2 may vary depending of the embodiment. For example, if a Token2 is received from the user device, the method may involve determining whether the Token2 corresponds to a Token1 or whether it corresponds to a Token2 stored against the channel. In another embodiment, the method can involve determining within the channel database whether there is a Token2 for the user for the channel. In any event, the end of the determination is either that the channel is authorised 524 or the channel is not authorised 525.

It will be appreciated that the Token2 can expire prior to expiration of Token1, after an actual nominated date, after a set period of time (say, 12 months), amount of usage or after a frequency of use (say, 10 uses)—at which point the Token1 may be still be in place and the Token2 would be need to be renewed. These token attributes 224 are in order to enable the token expirer 213 to expire the Token2.

Each Token1 and Token2 may have a one to one relationship only for further security reasons. Where a Token1 is compromised, deleted, disabled or removed, the Token2 associated with that Token1 disappears.

### EXAMPLE 1

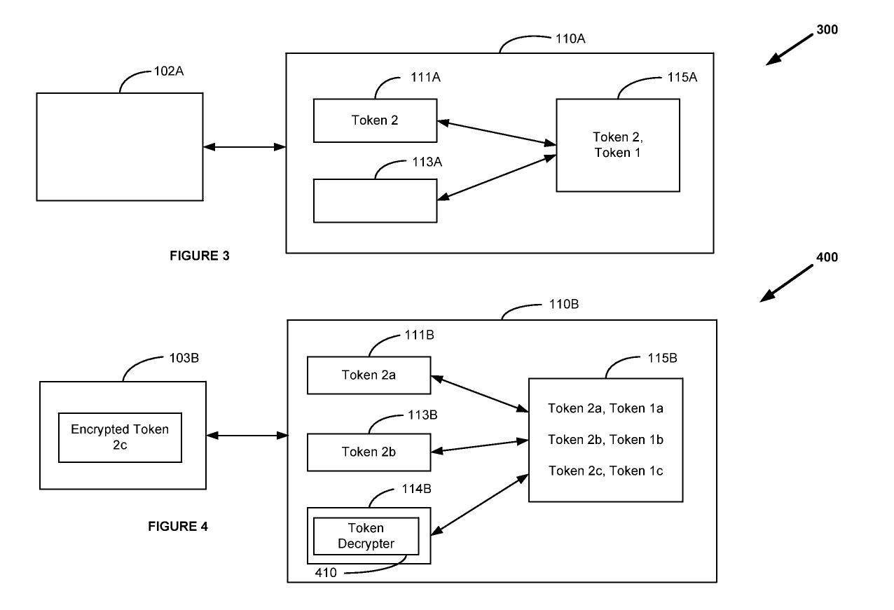

Referring to FIG. 3 elements from FIGS. 1 and 2 are appended by the letter “A” to provide an example of where merchant tokens may be stored. In the example, a father may have 3 children using pre-paid mobile phones and wish to recharge the credit for those phones on a regular basis through an auto-recharge subscription service 111A. The father enables the stored credit card functionality for the auto-recharge function as only he has access to the function as the account holder. This results in the creation of a Token2 within auto-recharge subscription service 111A. Token2 is also stored in the user account manager 115A in association with the Token1 corresponding to the father's credit card. All three children's mobile accounts can be recharged as efficiently as possible.

However, one of the children runs out of credit before time and seeks to recharge his account through an alternative payment channel, the IVR system 113A using phone 102A. As a Token1 has been created, that child seeks to attempt access through the IVR payment interface module 113A, hoping that the Token1 would be available.

However, a Token2 has not been established for use in the IVR system 113A (as indicated by the shading of block 113A) for the child's mobile number and hence the child is blocked from performing a transaction using a stored acquirer Token1.

Under the standard single token process, the Token1 created for the credit card would simply be applied against the account and not the payment channel. This is known as ‘token leakage’. The Token2 process does not suffer this problem.

In a variant of this embodiment, the father may enable a second Token2 for the IVR payment interface module 113A which is only associated with the father's mobile device, allowing the father to recharge on an ad-hoc basis via the IVR system but preventing access by the children

### EXAMPLE 2

Referring to FIG. 4 elements from FIGS. 1 and 2 are appended by the letter “B” to provide an example of where merchant tokens may be stored in an example of isolated and managed payment channels. In this example, the Token2 process is applied to IVR 113B, Subscription Auto-Recharge (SAR) 111B and Mobile Self Care (MSC) mobile application 114B channels.

A customer can store a credit card for each of the channels independently but use the same credit card. In this example, a new Token1 is created with each new token creation process.

A Customer would store one channel first (for example IVR 113B). The IVR system 113B would ask the customer for the credit card and prompt to store the card during the transaction. Token1 a does not exist at this stage, so it is created. Token2a (for the IVR channel) is also created at the same time as per normal. The Token2a will expire of the credit card's expiry date if that date is reached before the frequency count is reached.

Customer then decides to establish a Subscription Auto-Recharge (SAR) process 111B, recharging his account for $30 every 30 days. An additional Token1b and Token2b are created for this process. This new Token2b expires on expiration of the credit card's expiry date.

The customer then uses the MSC channel 114 (to perform irregular data access top-ups) and is also prompted to store their credit card for that channel. The merchant system requests another new Token1c and creates a Token2c for the MSC 114B for security process. MSC 114B is also a less secure channel than IVR 113B because the recharge application 104 is stored on the smart phone 103, so a limitation on the frequency of use of the Token2c exists—the customer can only recharge using the Token2c to a total of 5 times before it expires. The Token2c will expire at the credit card's expiry date if that date is reached before the frequency count is reached. In the case of the MSC 114B, the Token2c may be stored on the smart phone 103 in encrypted form hence requiring a token decrypter 410 when the Token2c is received as part of the payment request from smart phone 103B.

By using separate acquirer tokens as well as separate merchant tokens, security is improved and the cancellation of any Token1 does not result in cancellations over other channels.

It will be understood to persons skilled in the art of the invention that many modifications may be made without departing from the spirit and scope of the invention, in particular it will be apparent that certain features of embodiments of the invention can be employed to form further embodiments.

For example, it will be appreciated that the components shown in the above embodiment need not be run by the merchant and can instead be run by different entities. Alternatively, some components may be run by the merchant and others may be run by service providers. In one example, different third party providers could provide the IVR 113 and account manager 115. In such embodiments, the use of the Token2s provides an additional advantage of removing the need for the IVR system 113 to be PCI security compliant as it would need to be if it had access to the Token1. That is, the IVR system 113 can rely on the PCI security compliance of the account manager.

Thus, certain of the above embodiments:
allow multiple payment tokens to be established for a customer and payment channel(s);
secure the pathway between the customer and the account manager independently of the security of a token between the account manager and the payment acquirer;
manage the use of tokens within various payment channels for security and exposure reasons; and
avoid the need for each payment interface module to be PCI security compliant in accordance with the standards maintained by the PCI Security Standards Council—https://www.pcisecuritystandards.org/.

Persons skilled in the art will appreciate that in accordance with known techniques, functionality at the server side of the network may be distributed over a plurality of different computers, for example for load balancing or security.

Further aspects of the method will be apparent from the above description of the system. It will be appreciated that at least part of the method will be implemented electronically, for example, digitally by a processor executing program code. In this respect, in the above description certain steps are described as being carried out by the system, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art will appreciate that program code provides a series of instructions executable by a processor.

Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for controlling usage of one or more acquirer tokens stored within a merchant system, the method comprising:
receiving a payment request to make a payment corresponding to a user account having associated therewith an acquirer token that enables payment to be made by communication of the acquirer token to an acquirer system;
determining whether to allow the payment to be made by communicating the acquirer token to the acquirer system based on whether a payment channel via which the payment request is received is authorised for use of the acquirer token; and
communicating the acquirer token to the acquirer system upon a positive determination to allow the payment.

2. A method as claimed in claim 1, comprising determining whether to allow the payment by determining whether there is a merchant token for the payment channel that has been associated with the acquirer token.

3. A method as claimed in claim 2, comprising receiving the merchant token from a user device.

4. A method as claimed in claim 2, comprising creating a new merchant token in response to a request from an authorised user.

5. A method as claimed in claim 4 comprising applying an expiry condition to the merchant token during creation of the merchant token that is independent of the acquirer token and expiring the merchant token upon the expiry condition being met.

6. A method as claimed in claim 2, comprising independently establishing a merchant token for each of a plurality of payment channels.

7. A method as claimed in claim 6, further comprising establishing a separate acquirer token for each merchant token.

8. A method as claimed in claim 1, comprising receiving the payment request at a payment interface of a merchant system.

9. A merchant system arranged to control usage of one or more acquirer tokens stored within the merchant system, the merchant system arranged to:
receive a payment request to make a payment corresponding to a user account having associated therewith an acquirer token that enables payment to be made by communication of the acquirer token to an acquirer system;
determine whether to allow the payment to be made by communicating the acquirer token to the acquirer system based on whether a payment channel via which the payment request is received is authorised for use of the acquirer token; and
communicate the acquirer token to the acquirer system upon a positive determination to allow the payment.

10. A merchant system as claimed in claim 9, arranged to determine whether to allow the payment by determining whether there is a merchant token for the payment channel that has been associated with the acquirer token.

11. A merchant system as claimed in claim 10, arranged to receive the merchant token from a user device.

12. A merchant system as claimed in claim 9, arranged to create a new merchant token in response to a request from an authorised user.

13. A merchant system as claimed in claim 12, arranged to apply an expiry condition to the merchant token during creation of the merchant token that is independent of the acquirer token and further arranged to expire the merchant token upon the expiry condition being met.

14. A merchant system as claimed in claim 9, arranged to independently establish a merchant token for each of a plurality of payment channels.

15. A merchant system as claimed in claim 14, further arranged to establish a separate acquirer token for each merchant token.

16. A merchant system as claimed in claim 9, arranged to receive the payment request at a payment interface of the merchant system.

17. A merchant system comprising:
a plurality of payment interface modules, each corresponding to at least one different payment channel for communicating with the merchant system to make a payment corresponding to a user account, wherein a first payment interface module stores a merchant token for a first user; and
a user account manager storing a plurality of user records including a user record for the first user, the first user record storing the merchant token in association with an acquirer token that enables payment to be made by communication of the acquirer token to an acquirer system,
wherein the first payment interface module is arranged to process a payment request associated with the first user and allow the payment request to continue upon successfully checking the presence of the merchant token, and thereafter communicate the merchant token to the user account manager as part of the payment request, and
the user account manager is arranged to receive the merchant token and, upon successfully checking that the merchant token is stored in association with the acquirer token, communicate the acquirer token to the acquirer system.

18. A merchant system as claimed in claim 17, wherein a second payment interface module stores an additional merchant token for a first user; and
the user account manager stores the additional merchant token in association with the acquirer token that enables payment to be made by communication of the acquirer token to an acquirer system,
wherein the second payment interface module is arranged to process a payment request associated with the first user and allow the payment request to continue upon successfully checking the presence of the additional merchant token, and thereafter communicate the additional merchant token to the user account manager as part of the payment request, and
the user account manager is arranged to receive the additional merchant token and, upon successfully checking that the additional merchant token is stored in association with the acquirer token, communicate the acquirer token to the acquirer system.

19. A merchant system as claimed in claim 17, wherein a second payment interface module stores an additional merchant token for a first user; and
the user account manager stores the additional merchant token in association with an additional acquirer token that enables payment to be made by communication of the acquirer token to an acquirer system,
wherein the second payment interface module is arranged to process a payment request associated with the first user and allow the payment request to continue upon successfully checking the presence of the additional merchant token, and thereafter communicate the additional merchant token to the user account manager as part of the payment request, and
the user account manager is arranged to receive the additional merchant token and, upon successfully checking that the additional merchant token is stored in association with the additional acquirer token, communicate the additional acquirer token to the acquirer system.
